(19) United States
(12) Patent Application Publication
(10) Pub. No.: US 2025/0390195 A1
(43) Pub. Date: Dec. 25, 2025

(54) DETAILED CONTOUR COMPOSITION FOR VISUAL AVIONICS SYMBOLOGY DETECTION

(71) Applicant: Rockwell Collins, Inc., Cedar Rapids, IA (US)

(72) Inventor: Kollin G. Burns, Cedar Rapids, IA (US)

(21) Appl. No.: 18/753,670

(22) Filed: Jun. 25, 2024

(51) Int. Cl. G06F 3/0481; B64D 43/00

(52) U.S. Cl. CPC G06F 3/0481; B64D 43/00

(57) ABSTRACT

A verification computer may detect symbology with a graphical user interface by applying color segmentation to the graphical user interface, computing feature descriptions for each detected contour, using the feature descriptions as a composition while retaining the contours' relative spatial information to define the overall symbology element, and detecting matching symbology to the composition within the reference image index. A cockpit display system may generate the graphical user interface using one or more widgets.

### TECHNICAL FIELD

The present disclosure generally relates to aircraft installations, and more specifically to testing or inspecting aircraft displays.

### BACKGROUND

User applications within avionics systems may cause cockpit display systems to generate graphical user interfaces. The user applications must be verified to certify that the user applications cause the cockpit display systems to generate the graphical user interfaces in a manner which is compliant with various regulations.

Visual symbology verification accounts for a significant percentage of avionics systems testing. To automate this verification requires the ability to automatically detect the visual presence or state of the symbology. The wide variety (gauges, icons, flags, cursors, etc.) and relative complexity of avionics symbology present many challenges for defining a single solution with wide applicability, efficient performance, and the necessary accuracy for certification.

Reference images (e.g., golden images) have been used for automated visual verification of the graphical user interfaces. The use of reference images relies on pixel-perfect matches which incur maintenance overhead when even unrelated changes occur. Therefore, it would be advantageous to provide a device, system, and method that cures the shortcomings described above.

### SUMMARY

In some aspects, the techniques described herein relate to a method including: segmenting a graphical user interface (GUI) by a plurality of GUI colors into a plurality of color-segmented graphical user interfaces; detecting a plurality of contours within the plurality of color-segmented graphical user interfaces; computing a plurality of GUI feature descriptions and a plurality of GUI bounds for the plurality of contours; combining the plurality of GUI colors, the plurality of GUI feature descriptions, and the plurality of GUI bounds into a GUI composition; and comparing the GUI composition with a widget composition of a widget to detect the widget composition is present in the graphical user interface.

In some aspects, the techniques described herein relate to a method, wherein the widget composition includes a plurality of widget colors, a plurality of widget feature descriptions, and a plurality of widget bounds, wherein comparing the GUI composition with the widget composition to detect the widget composition is present in the graphical user interface includes: matching the plurality of widget feature descriptions to the plurality of GUI feature descriptions and verifying that the plurality of widget colors associated with the plurality of widget feature descriptions match the plurality of GUI colors which are associated with the plurality of GUI feature descriptions; determine a plurality of widget origin points in the graphical user interface for the plurality of GUI feature descriptions which match the plurality of widget feature descriptions based on the plurality of widget bounds and the plurality of GUI bounds; and determining the plurality of widget origin points are at a common point on the graphical user interface.

In some aspects, the techniques described herein relate to a method, wherein a pixel tolerance is added to the plurality of widget origin points when determining the plurality of widget origin points are at the common point.

In some aspects, the techniques described herein relate to a method, wherein the plurality of GUI feature descriptions include at least one of edges, corners, blobs, ridges, colors, key points, or moments.

In some aspects, the techniques described herein relate to a method, wherein the plurality of GUI feature descriptions are Zernike moments.

In some aspects, the techniques described herein relate to a method, wherein each of the plurality of color-segmented graphical user interfaces includes one or more of the plurality of contours.

In some aspects, the techniques described herein relate to a method, wherein the plurality of GUI bounds include a position of the plurality of contours and a size of the plurality of contours.

In some aspects, the techniques described herein relate to a verification computer including: a memory maintaining program instructions; and one or more processors configured to execute the program instructions causing the one or more processors to: segment a graphical user interface (GUI) by a plurality of GUI colors into a plurality of color-segmented graphical user interfaces; detect a plurality of contours within the plurality of color-segmented graphical user interfaces; compute a plurality of GUI feature descriptions and a plurality of GUI bounds for the plurality of contours; combine the plurality of GUI colors, the plurality of GUI feature descriptions, and the plurality of GUI bounds into a GUI composition; and compare the GUI composition with a widget composition of a widget to detect the widget composition is present in the graphical user interface.

In some aspects, the techniques described herein relate to a verification computer, wherein the verification computer is configured to generate the widget composition and maintain the widget composition in the memory.

In some aspects, the techniques described herein relate to a verification computer, wherein the widget composition includes a plurality of widget colors, a plurality of widget feature descriptions, and a plurality of widget bounds, wherein comparing the GUI composition with the widget composition to detect the widget composition is present in the graphical user interface includes: matching the plurality of widget feature descriptions to the plurality of GUI feature descriptions and verifying that the plurality of widget colors associated with the plurality of widget feature descriptions match the plurality of GUI colors which are associated with the plurality of GUI feature descriptions; determine a plurality of widget origin points in the graphical user interface for the plurality of GUI feature descriptions which match the plurality of widget feature descriptions based on the plurality of widget bounds and the plurality of GUI bounds; and determining the plurality of widget origin points are at a common point on the graphical user interface.

In some aspects, the techniques described herein relate to a verification computer, wherein a pixel tolerance is added to the plurality of widget origin points when determining the plurality of widget origin points are at the common point.

In some aspects, the techniques described herein relate to a verification computer, wherein the plurality of GUI feature descriptions include at least one of edges, corners, blobs, ridges, colors, key points, or moments.

In some aspects, the techniques described herein relate to a verification computer, wherein the plurality of GUI feature descriptions are Zernike moments.

In some aspects, the techniques described herein relate to a verification computer, wherein each of the plurality of color-segmented graphical user interfaces includes one or more of the plurality of contours.

In some aspects, the techniques described herein relate to a system including: a verification computer including: a memory maintaining program instructions; and one or more processors configured to execute the program instructions causing the one or more processors to: segment a graphical user interface (GUI) by a plurality of GUI colors into a plurality of color-segmented graphical user interfaces; detect a plurality of contours within the plurality of color-segmented graphical user interfaces; compute a plurality of GUI feature descriptions and a plurality of GUI bounds for the plurality of contours; combine the plurality of GUI colors, the plurality of GUI feature descriptions, and the plurality of GUI bounds into a GUI composition; and compare the GUI composition with a widget composition of a widget to detect the widget composition is present in the graphical user interface; and a cockpit display system including one or more definition files defining the widget, wherein the cockpit display system is configured to generate the graphical user interface.

In some aspects, the techniques described herein relate to a system, an avionics system configured to execute one or more user applications, wherein the one or more user applications generates one or more function calls to the cockpit display system, wherein the cockpit display system is configured to generate the graphical user interface based on the one or more function calls.

In some aspects, the techniques described herein relate to a system, including one or more sensors configured to generate avionics data, wherein the one or more user applications generate the one or more function calls based on the avionics data.

In some aspects, the techniques described herein relate to a system, including one or more user interface elements, wherein the one or more user applications are configured to update the one or more function calls based on user interface feedback from the one or more user interface elements.

In some aspects, the techniques described herein relate to a system, including one or more flight displays, wherein the cockpit display system causes the one or more flight displays to display the graphical user interface.

In some aspects, the techniques described herein relate to a system, wherein the widget composition includes a plurality of widget colors, a plurality of widget feature descriptions, and a plurality of widget bounds, wherein comparing the GUI composition with the widget composition to detect the widget composition is present in the graphical user interface includes: matching the plurality of widget feature descriptions to the plurality of GUI feature descriptions and verifying that the plurality of widget colors associated with the plurality of widget feature descriptions match the plurality of GUI colors which are associated with the plurality of GUI feature descriptions; determine a plurality of widget origin points in the graphical user interface for the plurality of GUI feature descriptions which match the plurality of widget feature descriptions based on the plurality of widget bounds and the plurality of GUI bounds; and determining the plurality of widget origin points are at a common point on the graphical user interface.

### BRIEF DESCRIPTION OF THE DRAWINGS

Implementations of the concepts disclosed herein may be better understood when consideration is given to the following detailed description thereof. Such description refers to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 depicts a cockpit of an aircraft, in accordance with one or more embodiments of the present disclosure.

FIG. 2 depicts a block diagram of a system, in accordance with one or more embodiments of the present disclosure.

FIG. 3 depicts a flow diagram of a method, in accordance with one or more embodiments of the present disclosure.

FIGS. 4A-4E depict an example of determining a widget composition, in accordance with one or more embodiments of the present disclosure.

FIGS. 5A-5S depict an example of detecting a match between the widget composition and a GUI composition, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details are set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Reference will now be made in detail to the subject matter disclosed, which is illustrated in the accompanying drawings. Embodiments of the present disclosure are directed to Detailed Contour Composition for Visual Avionics Symbology Detection. A verification computer may detect symbology with a graphical user interface by applying color segmentation to the graphical user interface, computing feature descriptions for each detected contour, using the feature descriptions as a composition while retaining the contours' relative spatial information to define the overall symbology element, and detecting matching symbology to the composition within the reference image index. A cockpit display system may generate the graphical user interface using one or more widgets.

U.S. Pat. No. 10,545,639B1, titled “Run-time widget creating system, device, and method”; U.S. Pat. No. 10,163,185B1, titled “Systems and methods for user driven avionics graphics”; U.S. Pat. No. 11,851,215B2, titled “Systems and methods for calibrating a synthetic image on an avionic display”; and U.S. Patent Publication Number US20230419647A1, titled “Methods and systems for automated display verification”; are incorporated herein by reference in the entirety.

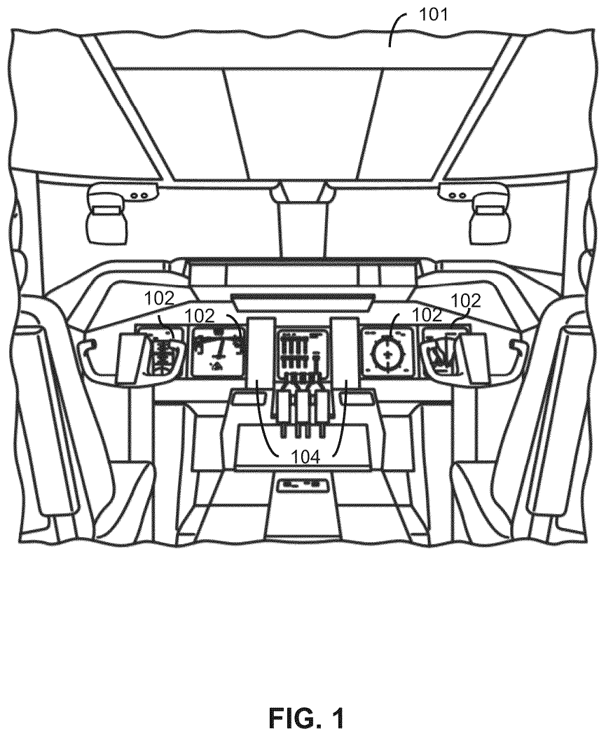

FIG. 1 depicts a cockpit 101 of an aircraft 100, in accordance with one or more embodiments of the present disclosure. The cockpit 101 may be configured for a pilot to interact with avionics systems of the aircraft 100. The aircraft 100 may include flight displays 102 and user interface elements 104 (“UI” elements).

The flight displays 102 may be implemented using any of a variety of display technologies, including CRT, LCD, organic LED, dot matrix display, and others. The flight displays 102 may be navigation (NAV) displays, primary flight displays, electronic flight bag displays, tablets or tablet computers, synthetic vision system displays, head up displays (HUDs) with or without a projector, wearable displays, watches, and the like. The flight displays 102 may be used to provide information to the flight crew, thereby increasing visual range and enhancing decision-making abilities. One or more of the flight displays 102 may be configured to function as, for example, a primary flight display (PFD) used to display altitude, airspeed, vertical speed, and navigation and traffic collision avoidance system (TCAS) advisories. One or more of the flight displays 102 may also be configured to function as, for example, a multi-function display used to display navigation maps, weather radar, electronic charts, TCAS traffic, aircraft maintenance data and electronic checklists, manuals, and procedures. One or more of the flight displays 102 may also be configured to function as, for example, an engine indicating and crew-alerting system (EICAS) display used to display critical engine and system status data. Other types and functions of the flight displays 102 are contemplated as well. According to various exemplary embodiments of the inventive concepts disclosed herein, at least one of the flight displays 102 may be configured to display a visual representation of a widget generated according to the systems and methods of the inventive concepts disclosed herein.

The flight displays 102 may provide an output based on data received from a system external to an aircraft, such as a ground-based weather radar system, satellite-based system, or from a system of another aircraft. The flight displays 102 may provide an output from an onboard aircraft-based weather radar system, LIDAR system, infrared system, or other system on an aircraft. For example, the flight displays 102 may include a weather display, a weather radar map, and a terrain display. The flight displays 102 may provide an output based on a combination of data received from multiple external systems or from at least one external system and an onboard aircraft-based system. The flight displays 102 may include an electronic display or a synthetic vision system (SVS). For example, the flight displays 102 may include a display configured to display a two-dimensional (2-D) image, a three-dimensional (3-D) perspective image of terrain and/or weather information, or a four-dimensional (4-D) display of weather information or forecast information. Other views of terrain and/or weather information may also be provided (e.g., plan view, horizontal view, vertical view). The views may include monochrome or color graphical representations of the terrain and/or weather information. Graphical representations of weather or terrain may include an indication of altitude of the weather or terrain or the altitude relative to an aircraft.

The user interface elements 104 may include, for example, dials, switches, buttons, touch screens, keyboards, a mouse, joysticks, cursor control devices (CCDs), menus on Multi-Functional Displays (MFDs), or other multi-function key pads certified for use with avionics systems. The user interface elements 104 may be incorporated by the flight displays 102 (e.g., the user interface elements 104 may appear on or be part of the flight displays 102). The user interface elements 104 may be configured to, for example, allow an aircraft crew member to interact with various avionics applications and perform functions such as data entry, manipulation of navigation maps, and moving among and selecting checklist items. For example, the user interface elements 104 may be used to adjust features of the flight displays 102, such as contrast, brightness, width, and length. The user interface elements 104 may also be used by an aircraft crew member to interface with or manipulate the displays of the flight displays 102. For example, the user interface elements 104 may be used by aircraft crew members to adjust the brightness, contrast, and information displayed on the flight displays 102. The user interface elements 104 may additionally be used to acknowledge or dismiss an indicator provided by the flight displays 102. The user interface elements 104 may be used to correct errors on the flight displays 102. The user interface elements 104 may also be used to adjust the radar antenna tilt, radar display gain, and to select vertical sweep azimuths. The user interface elements 104 may also include indicator lights, displays, display elements, and audio alerting devices. The user interface elements 104 may be configured to warn of potentially threatening conditions such as severe weather, terrain, and obstacles, such as potential collisions with other aircraft.

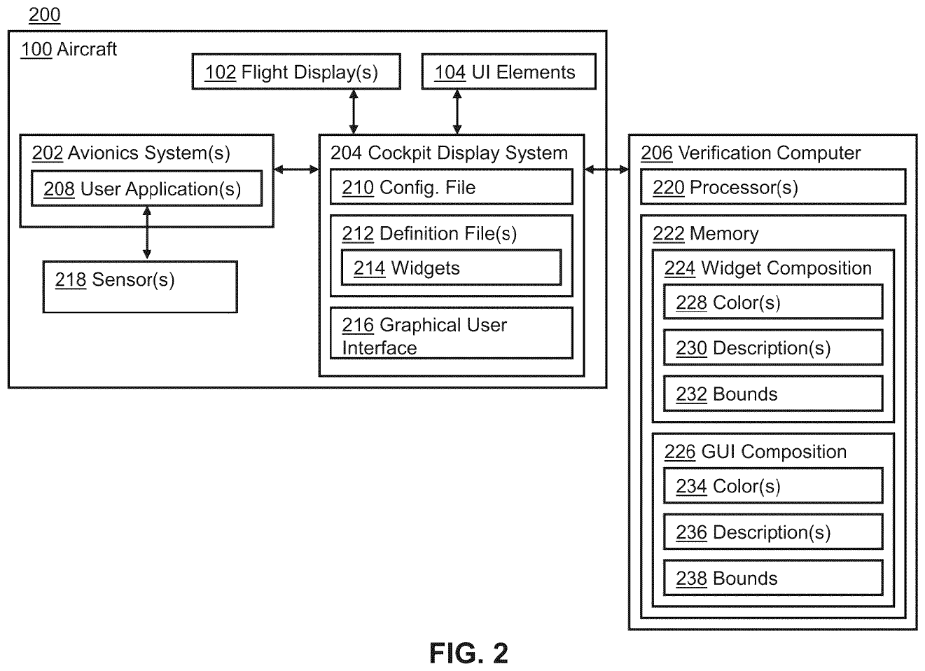

FIG. 2 depicts a system 200, in accordance with one or more embodiments of the present disclosure. The system 200 may include the flight displays 102, user interface elements 104, avionics systems 202, a cockpit display system 204, a verification computer 206, sensors 218, and the like.

The flight displays 102, the avionics systems 202, and/or the cockpit display system 204 may be configured according to ARINC 661 entitled “Cockpit Display System Interfaces to User Systems”.

One or more components of the system 200 may be disposed within the aircraft 100. For example, the flight displays 102 may be disposed in the cockpit 101. By way of another example, the avionics systems 202 may be disposed within an electronics bay of the aircraft 100. By way of another example, the sensors 218 may be disposed at various locations within the aircraft 100. One or more components of the system 200 may also be disposed outside of the aircraft 100. For example, the verification computer 206 may be disposed outside of the aircraft 100, although this is not intended to be limiting. It is further contemplated that the verification computer 206 may be disposed within the aircraft 100.

The avionics systems 202 may be configured to execute user applications 208. Examples of the avionics systems 202 that include the user applications 208 include, but are not limited to, air conditioning, auto flight, communications, electrical power, equipment and furnishings, fire protection, flight controls, fuel, hydraulic power, ice and rain protection, instruments, landing gear, lights, navigation, oxygen, pneumatic, vacuum, waste/water, central maintenance system, auxiliary power unit, propellers, main rotor, main rotor drive, tail rotor, tail rotor drive, rotors flight control, propeller/rotor systems, and powerplant systems. The navigation system may include a flight management system (“FMS”), traffic collision and avoidance system (“TCAS”), automatic dependent surveillance-broadcast system (“ADS-B”), a forward-looking radar system, and terrain awareness and warning system (“TAWS”), and the like.

The user applications 208 may generate function calls to widget generation functions and transport the function calls to the cockpit display system 204.

The user applications 208 may be software applications executed by processors (not depicted) of the avionics systems 202. The user applications 208 may be developed by an end user and included in the avionics systems 202. The user applications 208 may be integrated with other components of the aircraft 100.

The sensors 218 may be configured to generate avionics data. The user applications 208 may the receive the avionics data from the sensors 218. The user applications 208 may generate the function calls based on the avionics data. For example, if the avionics data is an airspeed, the user applications 208 can receive the airspeed and generate the function calls based on the airspeed so that the flight displays 102 display the airspeed.

The avionics systems 202 and the cockpit display system 204 may bidirectionally communicate using one or more communication interfaces. The cockpit display system 204 may be an interface between the avionics systems 202 and the flight displays 102.

The flight displays 102, the avionics system 202, and/or the cockpit display system 204 may be compatible with a standard graphics interface (e.g., the second graphics interface may be an ARINC-661 graphics application programming interface or compatible with an ARINC-661 specification).

The cockpit display system 204 may be a graphics server. For example, the cockpit display system 204 may be an ARINC 661 Graphics Server (AGS). The cockpit display system 204 may include a configuration file 210 (CF) and/or definition files 212 (DFs).

The configuration file 210 may configure the initial settings for the cockpit display system 204. The configuration file 210 may include instructions related to the user applications 208 and the layers owned by the avionics systems 202. The configuration file 210 may include a configuration of the flight displays 102. For example, the configuration file 210 may include a resolution, pixel density, aspect ratio, screen size, and the like of the flight displays 102. The configuration file 210 may include instructions for loading and interpreting the definition files 212.

The definition files 212 may define the widgets 214. The definition files 212 may describe a hierarchical structure of widgets 214 assigned to layers. The widgets 214 may be considered building blocks. Each of the widgets 214 may be defined by a set of parameters that control the graphical and/or interactive characteristics of the widgets 214, where each parameter could be fixed or modified during runtime, i.e., a runtime parameter. Examples of parameters of the widgets 214 include, but are not limited to, visibility and enablement. Also, the widgets 214 may include a graphical look that represents how the widgets 214 will appear when drawn on the flight displays 102. The cockpit display system 204 may load and display the widgets 214 listed in the definition files 212. The definition files 212 may define the color and/or visibility of the widgets 214. The definition files 212 may also define the position and/or the size of the widgets 214.

The widgets 214 may also be referred to as graphical widgets. The widgets 214 may include: a container or logical widget (e.g., basic container, mutually exclusive container, radio box, etc.), a graphical representation widget (e.g., edit box text, graphical primitive (“GP”) line, GP rectangle, label, push button, toggle button, etc.), a text string widget (edit box text, label, push button, toggle button, etc.), an interactive widget (e.g., edit box text, push button, toggle button, etc.), a map management widget (e.g., map grid, horizontal map, horizontal map source, horizontal map item list, etc.), a dynamic motion widget (e.g., GP line, GP rectangle, label, etc.), a utility widget (e.g., connector, cursor reference, etc.), and a UA validation widget (e.g., basic container, edit box text, horizontal map, horizontal map source, mutually exclusive container, push button, radio box, toggle button, etc.), gauges, state values, or the like. The widgets 214 may include flags. Flags may be text inside boxes, usually amber or red. Per requirements, flags can also be just floating text.

The cockpit display system 204 may generate a graphical user interface 216 (GUI). The graphical user interface 216 may also be referred to as runtime images, an image to be searched, dynamic avionics graphics, or the like.

The cockpit display system 204 may generate the graphical user interface 216 based on the function calls from the user applications 208. For example, the cockpit display system 204 may generate the graphical user interface 216 with layers of the widgets 214 based on the commands from the user applications 208. Each of the layers may include a single of the widgets 214 or a grouping of the widgets 214. The graphical user interface 216 may be captured from the cockpit display system 204. The size of the graphical user interface 216 may be larger than the widgets 214. For example, the graphical user interface 216 may include many of the widgets 214 which are composited together to form the graphical user interface 216.

The graphical user interface 216 may include various information, such as, but not limited to, flight instruments (e.g., airspeed, attitude, altitude, and heading), magnetic heading, actual magnetic track, airspeeds, altitudes, barometric correction setting, vertical speed displays, flight path angle and drift angles, flight director commands, limiting and operational speeds, Mach number, radio altitude and decision height, final approach trajectory deviations, marker indications, and the like.

The cockpit display system 204 may cause the flight displays 102 to display the graphical user interface 216. The user applications 208 may manage the logic, position, and state of the widgets 214 within the graphical user interface 216. The flight displays 102 may display the graphical user interface 216.

The configuration file 210 may include instructions for establishing a communication link with one or more of the user interface elements 104. The cockpit display system 204 may receive user interface feedback from the user interface elements 104. The cockpit display system 204 may provide the user interface feedback to the user applications 208. The user applications 208 may update the function calls based to the cockpit display system 204 based on the user interface feedback.

The verification computer 206 may include processors 220 and memory 222.

The processors 220 may include any one or more processing elements. In this sense, the processors may include any microprocessor-type device configured to execute software algorithms and/or instructions. The processors may be any device having one or more processing elements, which execute program instructions from memory. For example, the processors may include a multi-core processor, a single-core processor, a reconfigurable logic device (e.g., FPGAs), a digital signal processor (DSP), a special purpose logic device (e.g., ASICs), or other integrated formats. Aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software/and or firmware would be well within the skill of one skilled in the art in light of this disclosure. Such hardware, software, and/or firmware implementation may be a design choice based on various cost, efficiency, or other metrics. In this sense, the processor(s) may include any microprocessor-type device configured to execute software algorithms and/or instructions. In general, the term “processor” may be broadly defined to encompass any device having one or more processing elements, which execute program instructions from memory, from firmware, or by hardware implemented functions. It should be recognized that the steps described throughout the present disclosure may be carried out by the processors.

The memory 222 may include any storage medium known in the art. For example, the storage medium may include a non-transitory memory medium. For instance, the non-transitory memory medium may include, but is not limited to, a read-only memory (ROM), a random-access memory (RAM), a magnetic or optical memory device (e.g., disk), a solid-state drive and the like. It is further noted that memory may be housed in a common controller housing with the one or more processor(s). For example, the memory and the processors may be housed in a processing unit, a desktop computer, or the like. In an alternative embodiment, the memory may be located remotely with respect to the physical location of the processor. In another embodiment, the memory maintains program instructions for causing the processor(s) to carry out the various steps described through the present disclosure.

The verification computer 206 may receive the graphical user interface 216 from the cockpit display system 204. The verification computer 206 may verify the graphical user interface 216. The graphical user interface 216 may be verified to ensure the integrity of the user applications 208 and the cockpit display system 204. The verification computer 206 may execute one or more methods to verify the graphical user interface 216. For example, the verification computer 206 may apply color segmentation to the graphical user interface 216, compute feature descriptions for each detected contour, use the feature descriptions as a composition while retaining the contours' relative spatial information to define the overall symbology element, and detect matching symbology to the composition. The method may enable automated systems verification of the user applications 208 and the cockpit display system 204.

The verification computer 206 may be configured to generate a widget composition 224 and/or a GUI composition 226. The verification computer 206 may maintain the widget composition 224 and/or the GUI composition 226 in the memory 222 in response to generating the widget composition 224 and/or the GUI composition 226. The widget composition 224 and/or the GUI composition 226 may be stored in an index, database, or the like. The verification computer 206 may maintain the widgets 214 and/or the widget compositions of the widgets 214. For example, the verification computer 206 may maintain the widgets 214 and the compositions of the widgets 214 as a library of reference images and compositions of the reference images.

The widget composition 224 and/or the GUI composition 226 may be an overall definition of the contours of the widgets 214 and the graphical user interface 216, respectively. The widget composition 224 and/or the GUI composition 226 may include information regarding the contours of the graphical user interface 216. For example, the composition may include the colors of the contours, the bounding boxes of the contours, and the feature descriptions of the contours. The widget composition 224 may include widget colors 228, widget feature descriptions 230, and/or widget bounds 232. The GUI composition 226 may include GUI colors 234, the GUI feature descriptions 236, and/or GUI bounds 238.

The GUI composition 226 may or may not define all portions of the graphical user interface 216. For example, the colors which are not segmented into the color-segmented graphical user interfaces may not be included in the composition. Thus, non-essential pixels may be masked from the color-segmented graphical user interfaces to prevent the non-essential pixels from contributing to the composition.

The widgets 214 and/or the graphical user interface 216 may include a predefined set of the widget colors 228 and/or the GUI colors 234, respectively. The widget colors 228 and/or the GUI colors 234 may include up to 256 colors. In this regard, the widgets 214 and the graphical user interface 216 may support the widget colors 228 and/or the GUI colors 234. For example, the widget colors 228 and/or the GUI colors 234 may include cyan, yellow, magenta, white, green, and the like. Each of the widget colors 228 and/or the GUI colors 234 may be defined according to a color model. The color model may include, but is not limited to the RGB color model. Each of the widget colors 228 and/or the GUI colors 234 may include a red, green, and blue color value defining the colors.

The widget feature descriptions 230 and/or the GUI feature descriptions 236 may be collectively referred to as feature descriptions. The widget feature descriptions 230 and/or the GUI feature descriptions 236 may also be referred to as features, image feature descriptions, a feature vector, a feature space, or the like.

The widgets 214 and the graphical user interface 216 may be made of a plurality of contours. The contours may also be referred to as image contours, boundaries, or edges. The contours may be a curve joining all pixels which are contiguous within the widgets 214 and the graphical user interface 216 based on the widget colors 228 and GUI colors 234, respectively. The contiguous pixels may be pixels that are touching each other and form a continuous line. Pixels which are not contiguous are detected as being part of separate contours. Each of the contours may include a shape based on the shape of the curve joining all pixels which are contiguous.

The widget feature descriptions 230 and/or the GUI features descriptions 236 may define features of contours within the widgets 214 and the graphical user interface 216, respectively. The features of the contours may correspond to pixel intensities and pixel data that defines the contours. The features descriptions of the contours may include, but are not limited to, edges, corners, blobs, ridges, colors, key points, moments (e.g., Zernike moments, Hu moments, and the like), and the like. The number of features of the contours may be based on the widgets 214 which are used to generate the graphical user interface 216.

The widget feature descriptions 230 and/or the GUI features descriptions 236 may be an array. Each entry in the array may be a float, an integer, or the like. The array may define the various features of the contours of the widgets 214 and the graphical user interface 216, respectively. The array may include any integer number of the entries, where the integer number of the entries is based on the number of features of the contours.

The widget feature descriptions 230 and/or the GUI feature descriptions 236 may represent the contours of the widgets 214 and/or the graphical user interface 216, respectively in a compact form with a select level of accuracy. The widget feature descriptions 230 and/or the GUI feature descriptions 236 may be an abstraction of the contours. The widget feature descriptions 230 and/or the GUI feature descriptions 236 may not be pixel perfect representations of the contours. The widget feature descriptions 230 and/or the GUI feature descriptions 236 may reduce a digital footprint of the definition of the widgets 214 and/or the graphical user interface 216, thereby improving memory use and processing efficiency. The widget feature descriptions 230 and/or the GUI feature descriptions 236 may condense the contours such that feature descriptions may be unable to exactly recreate the contours.

The widget bounds 232 and/or the GUI bounds 238 may be collectively referred to as the bounds. The widget bounds 232 and/or the GUI bounds 238 may give the bounds of the contours are within the widgets 214 and the graphical user interface 216, respectively. The widget bounds 232 and/or the GUI bounds 238 may include a position of the contours and/or a size of the contours. The composition may retain the relative spatial information of the contours using the widget bounds 232 and/or the GUI bounds 238.

The position of the contours may be the location offset relative to the origin of the widgets 214 and/or the graphical user interface 216. The origin of the widgets 214 and/or the graphical user interface 216 may be one of the corners of the widgets 214 and/or the graphical user interface 216. For example, the origin of the widgets 214 and/or the graphical user interface 216 may be a top-left, a bottom-left, a top-right, or a bottom-right corner of the widgets 214 and/or the graphical user interface 216. The widget feature descriptions 230 and the GUI feature descriptions 236 may be defined relative to a common origin within the widgets 214 and the graphical user interface 216, respectively. The location offset may refer to the number of pixels in the horizontal and in the vertical relative to the origin.

The size of the contours may be a size of a bounding box which bounds the contours. The bounding box may include a rectangular shape. The size of the bounding box may be a smallest rectangle which includes all pixels of the contour. The size of the bounding box may be the number of pixels in the horizontal and in the vertical which encompass the contour.

The verification computer 206 may generate the widget composition 224 and/or the GUI composition 226. The verification computer 206 may generate the widget composition 224 and/or the GUI composition 226 from the widgets 214 and the graphical user interface 216, respectively.

The verification computer 206 may include a tool to assist with generating the widget compositions 224 and/or the GUI composition 226. The tool may allow generating an index or database of all the widgets 214 for quick querying.

The verification computer 206 may maintain the widgets 214 in a manifest file. The manifest file may include a feature, value, and name of the widgets 214. The verification computer 206 may generate the widget compositions 224 of the widgets 214 from the manifest file. The manifest file may be maintained in a file format, such as, but not limited to “json”. The value field is a string and can be anything that is helpful in identifying the reference image (e.g. a test case ID or a numerical value plus color specifier). The feature name and value strings may be used in a test procedure to look up the widgets 214. The information in the widgets 214 may vary depending on the test case. The information in the widgets 214 may contain the maximum amount of helpful information and nothing more. The widgets 214 may be tightly-cropped to ensure the widget bounding box within the widget compositions are well-fit to the widgets 214. A tighter cropping can also help reduce the amount of doctoring needed to remove any noise from the widgets 214. The widgets 214 may be cropped within a border to ensure that any aliased pixels that still pass the color filtering thresholds will still be included in the composition. The verification computer 206 may maintain the widget compositions 224 in a reference index.

The verification computer 206 may use the same processing on the widgets 214 and the graphical user interface 216 to ensure an accurate match can be made between the widget compositions 224 and the GUI compositions 226. For example, the verification computer 206 may generate the widget compositions 224 and/or the GUI compositions 226 from the widgets 214 and the graphical user interface 216, respectively, by segmenting the widgets 214 and/or the graphical user interface 216 into color-segmented widgets and/or color-segmented GUIs, detecting widget contours from the color-segmented widgets and/or GUI contours from the color-segmented GUIs, computing the widget feature descriptions 230 and/or widget bounds 232 for each of the widget contours, computing the GUI feature descriptions 236 and/or GUI bounds 238 for each of the GUI contours, combining the widget colors 228, widget feature descriptions 230, and/or widget bounds 232 into the widget compositions 224, and/or the combing the GUI colors 234, the GUI feature descriptions 236, and/or the GUI bounds 238 into the GUI compositions 226.

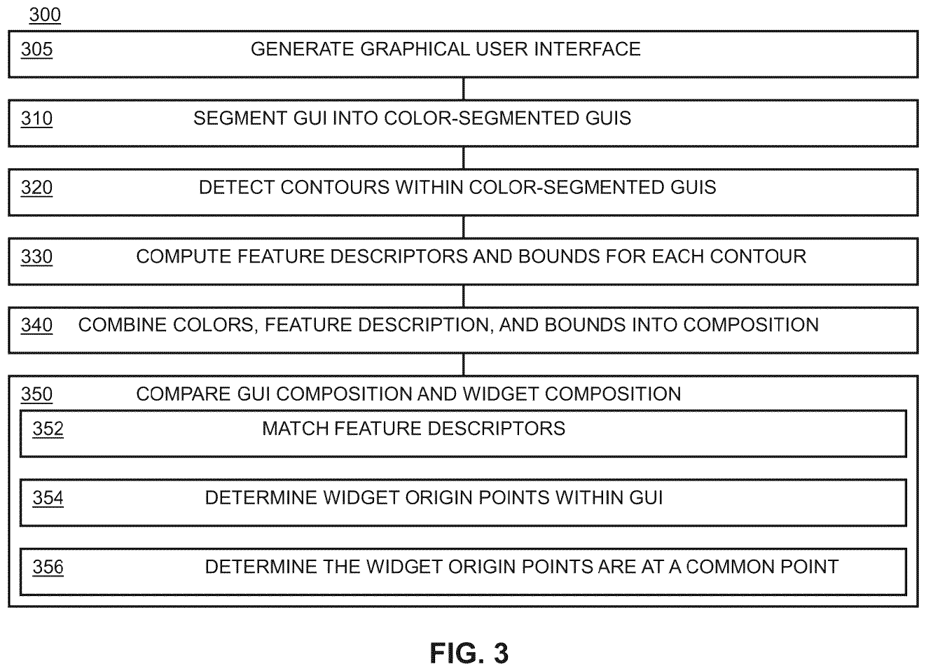

FIG. 3 depicts a flow diagram of a method 300, in accordance with one or more embodiments of the present disclosure. The method 300 provides a method for verifying the graphical user interface 216. The method 300 may be a Content-Based Image Retrieval (CBIR) approach for detecting the widgets 214 in the graphical user interface 216. The method 300 may enable automated verification when detecting the widgets 214 in the graphical user interface 216, even without pixel perfect matches. The method 300 may allow automated system level integration testing of the cockpit display system 204. The embodiments and the enabling technology described previously herein in the context of the verification computer 206, should be interpreted to extend to the method. It is further recognized, however, that the method is not limited to the verification computer 206.

In a step 305, the graphical user interface 216 may be generated. The cockpit display system 204 may generate the graphical user interface 216. The avionics system 202 may cause the cockpit display system 204 to generate the graphical user interface 216 based on initial conditions including a stimulus to trigger a behavior of the graphical user interface 216. For example, the avionics system 202 may perform test setup for the initial conditions and stimulus for the test procedure within a test framework. A test may be run to capture the graphical user interface 216 that contains the desired symbology state/value. The verification computer 206 may receive the graphical user interface 216 from the cockpit display system 204 for processing.

In a step 310, the graphical user interface 216 may be segmented by the GUI colors 234 into color-segmented graphical user interfaces. The verification computer 206 may segment the graphical user interface 216 into the color-segmented graphical user interfaces. Color segmenting may also be referred to as color filtering. Each of the color-segmented graphical user interfaces may include the portions of the graphical user interface 216 which correspond to the GUI colors 234. For example, the graphical user interface 216 may be segmented by the GUI colors 234 into cyan-colored, yellow-colored, magenta-colored, white-colored, and green-colored color-segmented graphical user interfaces. The cyan-colored, yellow-colored, magenta-colored, white-colored, and green-colored color-segmented graphical user interfaces may include only the cyan, yellow, magenta, white, and green portions of the graphical user interface 216, respectively.

The graphical user interface 216 may be segmented by colors into color-segmented graphical user interfaces based on the color values of the GUI colors 234. For example, pixels with color values which match the predefined set of color values may be segmented from the graphical user interface 216 into the color-segmented graphical user interfaces.

Segmenting the graphical user interface 216 by the GUI colors 234 into the color-segmented graphical user interfaces may reduce processing in further steps of the method 300.

Segmenting the graphical user interface 216 by the GUI colors 234 into the color-segmented graphical user interfaces may reduce noise. The noise may be associated with colors which are not segmented into the color-segmented graphical user interfaces. For example, the noise may be associated with background colors or other colors which are not part of a symbol to be verified. In this regard, not all the colors of the graphical user interface 216 may be segmented into the color-segmented graphical user interfaces.

In a step 320, contours may be detected within the color-segmented graphical user interfaces. The verification computer 206 may detect the contours within the color-segmented graphical user interfaces. The contours may be a curve joining all pixels which are contiguous within the color-segmented graphical user interfaces. Each of the color-segmented graphical user interfaces may include one or more of the contours. The number of the contours detected within the color-segmented graphical user interfaces may be based on the number of non-contiguous pixels.

Isolating the individual contours that define the color-segmented graphical user interface may reduce the definition of the color-segmented graphical user interface into the constituent parts. The contours may be defined more concisely than the color-segmented graphical user interfaces which may lead to more efficient processing in further steps of the method 300.

The contours may be detected within the color-segmented graphical user interfaces using one or more computer vision techniques. For example, the contours may be detected within the color-segmented graphical user interfaces using an Open-Source Computer Vision (OpenCV™) Library, or the like.

In a step 330, the GUI feature descriptions 236 and the GUI bounds 238 may be computed for the contours. The verification computer 206 may compute the GUI feature descriptions 236 and the GUI bounds 238 for each of the contours. The number of the GUI feature descriptions 236 may be based on the number of contours detected. There may be a one-to-one correspondence between the contours and the GUI feature descriptions 236. Each of the contours may include one of the GUI feature descriptions 236. Similarly, each of the GUI feature descriptions 236 may be associated with one of the contours.

The GUI feature descriptions 236 may be computed for each of the contours using one or more feature description methods. The features depends on the feature description method that is used to compute the feature descriptions. The feature description method may use the feature descriptions to define the contours. The values of the feature descriptions may be determined by applying the feature description method to the contours. For example, the feature descriptions may be computed for each of the contours using at least one Zernike moments, Hu moments, Scale-invariant feature transform (SIFT), speeded up robust features (SURF), Gradient Location and Orientation Histogram (GLOH), histogram of oriented gradients (HOG), and the like. For instance, the feature descriptions may be computed for each of the contours using Zernike moments. The Zernike moments may define the pixel intensities using one or more polynomial equations. The contours may be padded with a border of zero-intensity pixels to enable computation of the Zernike moments.

The same feature description method may be used when computing the widget feature descriptions 230 and when computing the computing the GUI feature descriptions 236.

Contours which are below a minimum-pixel threshold may be ignored for future processing. The minimum-pixel threshold may be selected based on the limitation of the feature description method used to generate the feature descriptions at which the feature description method may not discriminate between the various features.

In a step 340, the GUI colors 234, the GUI feature descriptions 236, and the GUI bounds 238 for the contours are combined into the GUI composition 226.

In a step 350, the GUI composition 226 may be compared with the widget composition 224 to detect the widget 214 is either present or absent in the graphical user interface 216. The verification computer 206 may compare the GUI composition 226 with the widget composition 224. The widget 214 may be verified to be in the graphical user interface 216 based on the comparison.

The GUI composition 226 may be compared with one of the widget compositions 224 to detect the widget composition 224 either is present or absent in the graphical user interface 216 as a query to verify for a specific instance of one of the widgets 214. Although the GUI composition 226 is described as compared with the widget compositions 224 to detect the widget compositions 224 is in the graphical user interface 216, this is not intended as a limitation of the present disclosure. A plurality of the widget compositions 224 may be compared against the GUI composition 226 to detect the plurality of the widget compositions 224 are/are not in the graphical user interface 216. The plurality of the widget compositions 224 may be selected based on one or more certification requirements of the graphical user interface 216.

The step 350 may include one or more sub-steps by which the GUI composition 226 may be compared with the widget composition 224 to detect the widget composition 224 either is present or absent in the graphical user interface 216.

In a sub-step 352, the widget feature descriptions 230 of the widget contours within the widget composition 224 are matched to the GUI feature descriptions 236 of the contours within the GUI composition 226. The verification computer 206 may match the widget feature descriptions 230 to the GUI feature descriptions 236. The verification computer 206 may also verify that the widget colors 228 associated with the widget feature descriptions 230 match the GUI colors 234 associated with the GUI feature descriptions 236. The verification computer 206 may record the matches in memory 222.

The widget feature descriptions 230 may match to multiple of the GUI feature descriptions 236. The graphical user interface 216 may include multiple instances of the widgets 214 from which the GUI feature descriptions 236 are generated. For example, the widget 214 may be a letter. The widget composition 224 may include the letter. The graphical user interface 216 may include multiple instances of the letter. The widget feature descriptions 230 of the letter may match to each of the GUI feature descriptions 236 which describe the letter in the graphical user interface 216. Each of the widget feature descriptions 230 may be added to a list to reduce false positives when matching the contours. Thus, the verification computer 206 may not stop when one of the widget feature descriptions 230 is found to match but rather may compare the widget feature descriptions 230 with each of the GUI feature descriptions 236.

In a sub-step 354, widget origin points 355 in the graphical user interface 216 for the GUI feature descriptions 236 which match the widget feature descriptions 230 are determined based on the widget bounds 232 and the GUI bounds 238. For example, the widget origin points 355 may be found by subtracting the widget position of the widget bounds 232 from the GUI position of GUI bounds 238. The verification computer 206 may determine the widget origin points 355.

In a sub-step 356, the widget origin points 355 for the widget feature descriptions 230 may be determined to be at a common point in the graphical user interface 216. The GUI composition 226 may be compared with the widget composition 224 to detect the widget 214 is present in the graphical user interface 216 when each of the widget origin points 355 for the widget feature descriptions 230 are at the common point on the graphical user interface 216. The widget origin points 355 may thus be used to track when all the widget feature descriptions 230 match to a common position within the graphical user interface 216.

The method 300 may enable accurate, efficient, certifiable, and automated verification of the graphical user interface 216. The method 300 may enable efficiently and accurately detecting a wide range of visual avionics symbology using the composition of color-segmented contours and their feature descriptions to define and use as a reference for the automated detection of visual avionics symbology. The combination of the color segmentation, contour detection, and feature descriptions may eliminate the reliance on pixel-perfect matches while maintaining the necessary accuracy for certification and efficiency for continuous automated verification. For example, the color segmentation may remove the need for pixel-perfect background matches between the widgets 214 and the graphical user interface 216. The method 300 is unlike a reverse image lookup in that the method 300 does not rely on pixel-perfect match or hardcoded coordinates. The match may not be a pixel-perfect match, because the feature descriptions are not pixel-perfect representations of the contours.

The definition files 212 may define the position and/or the size of the widgets 214 by screen units (e.g., in millimeters), as opposed to in pixels. The cockpit display system 204 may convert the screen units to pixels when generating the graphical user interface 216 from the widgets 214. The conversion of the screen units to pixels may cause the graphical user interface 216 to experience a pixel offset shift due to rounding to the nearest integer of pixels. For example, the widgets 214 within the graphical user interface 216 may be one pixel larger and/or smaller in width and/or height. By way of another example, the widgets 214 within the graphical user interface 216 may be horizontally positioned and/or vertically positioned one pixel offset from an expected position.

The pixel offset shift may vary between various of the flight displays 102 (e.g., based on the resolution of the flight displays 102). Furthermore, the pixel offset shift may vary based on a current configuration of the graphical user interface 216. For example, a window size of the graphical user interface 216 may be changed which may change the pixel offset shift. The window size of the graphical user interface 216 may be changed between a one-half full format, a two-thirds format, a strip format, or the like.

The verification computer 206 may allow fuzzy matching of the widget origin points 355 when determining the widget origin points 355 are at the common point. The contours can be shifted by a pixel when drawn in the graphical user interface 216. When computing the origin of the overall symbol based on the matched contour's coordinates, if the contour is off by a single pixel, the verification computer 206 may fail to detect the match between the widget composition 224 and the GUI composition 226 without performing the fuzzy matching. The fuzzy matching may also be referred to as tolerance matching. One approach could be to merge contour match arrays if the reference image origin coordinates are within one or more pixels from each other. For example, a pixel tolerance may be added to the widget origin points 355 when determining the widget origin points 355 are at the common point. The pixel tolerance may include +/−1 pixel, +/−2 pixels, or more. The fuzzy matching may accommodate the limitations associated with the generation of the graphical user interface 216 when converting between millimeters and pixels.

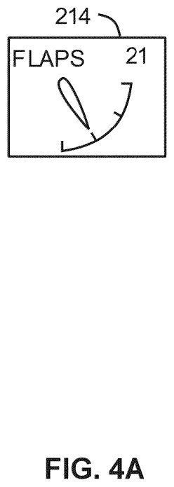

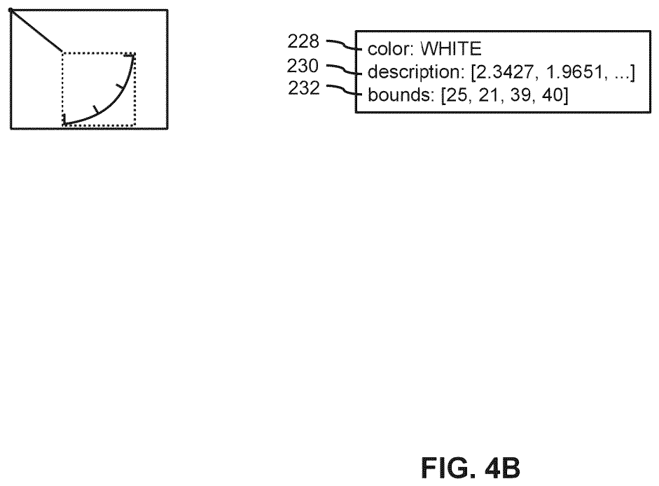

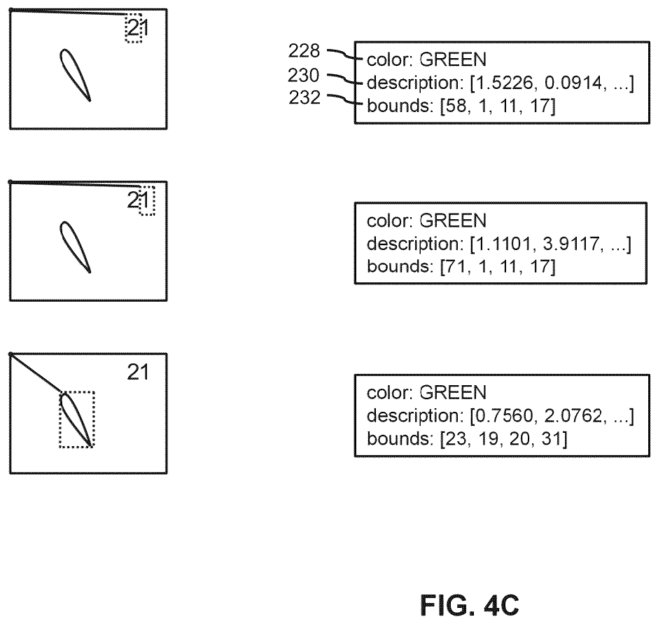

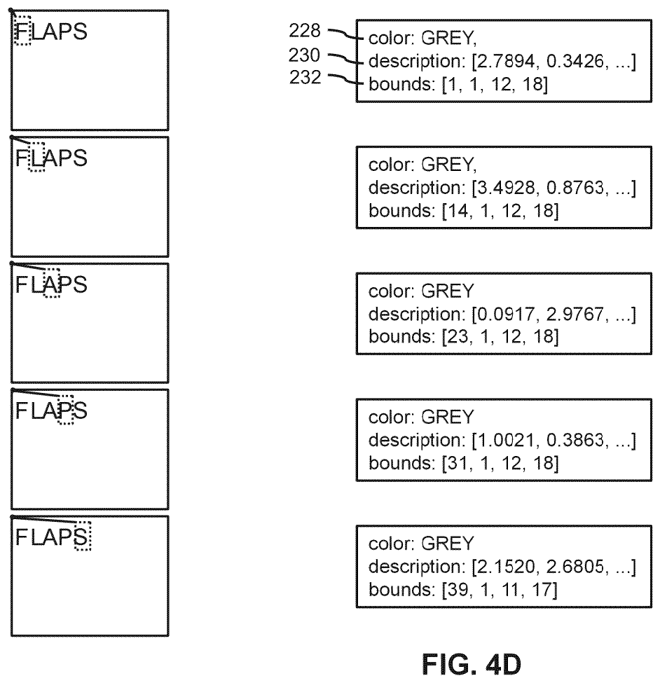

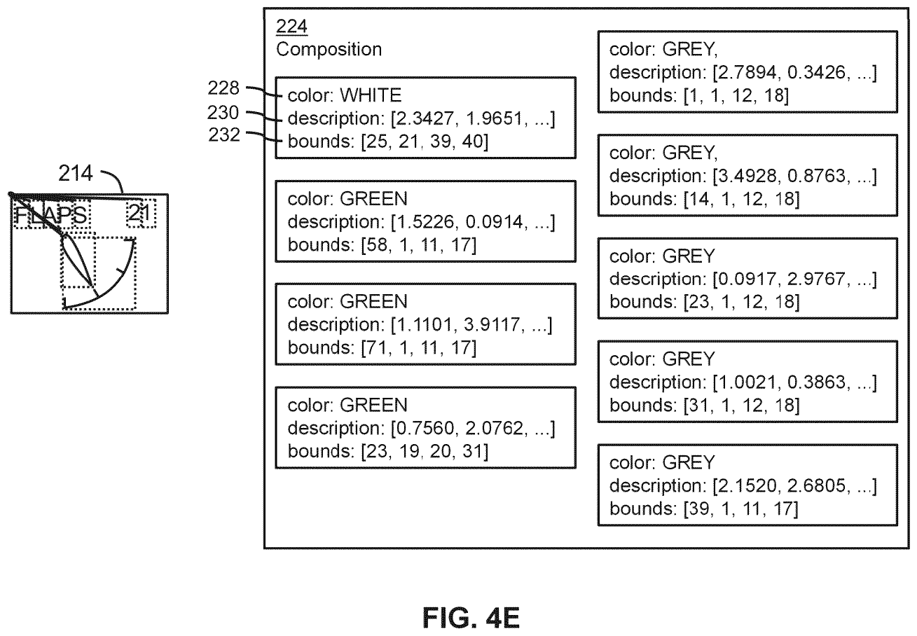

FIGS. 4A-4E depicts an example of generating the composition for the widget 214, in accordance with one or more embodiments of the present disclosure. In this example, the widget 214 is a flaps gauge. The flaps gauge may visually indicate an angular position of the flaps of the aircraft 100. The widget 214 may include three sets of the widget colors 228 (e.g., white, green, and grey). The white color may include a 90-degree dial scale. The green color may include a readout of the angular position (e.g., 21) and a pointer which points to an angular position on the 90-degree dial scale to indicate the angular position. The grey color may include a “FLAPS” indicator which indicates the widget 214 is a flaps gauge. The verification computer 206 may segment the white color, the green color, and the grey color as a white-segmented widget, a green-segmented widget, and a grey-segmented widget, respectively. The verification computer 206 may detect the following contours: the scale of the white-segmented widget, the 2, 1, and pointer of the green-segmented widget, and the F, L, A, P, and S of the grey-segmented widget. The verification computer 206 may compute the widget feature descriptions 230 and the widget bounds 232 for each of the following: the scale of the white-segmented widget, the 2, 1, and pointer of the green-segmented widget, and the F, L, A, P, and S of the grey-segmented widget. In this example, the widget feature descriptions 230 are floats with two of the features represented and with an ellipsis to represent the remainder of the features. In this example, the widget bounds 232 are represented in the following format: [x-axis position from origin to top-left of bounding box, y-axis position from origin to top-left of bounding box, size of bounding box in x-axis, size of bounding box in y-axis], where the units of the position and size are in number of pixels. The verification computer 206 may then combine the widget colors 228, the widget feature descriptions 230, and the widget bounds 232 into the widget composition 224. The widget composition 224 may represent the widget 214 using the widget colors 228, the widget feature descriptions 230, and the widget bounds 232.

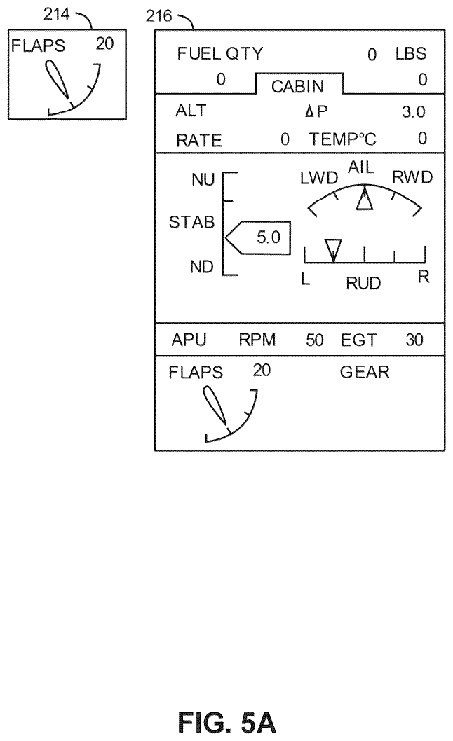

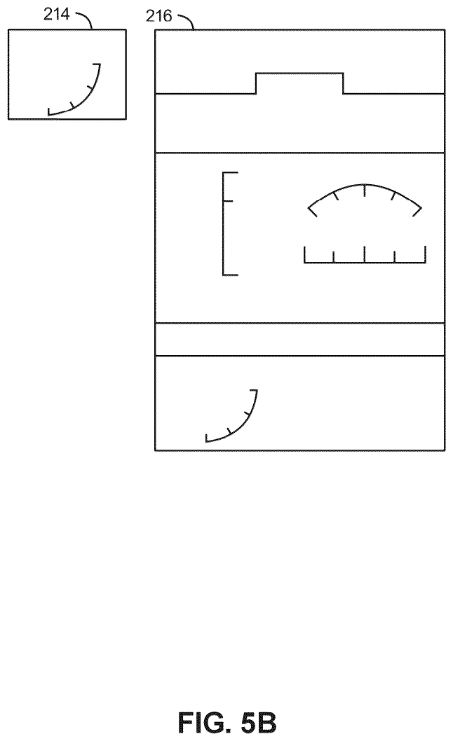

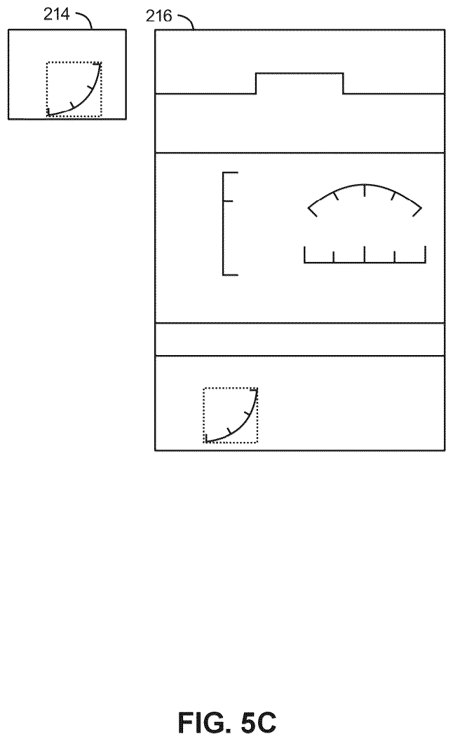

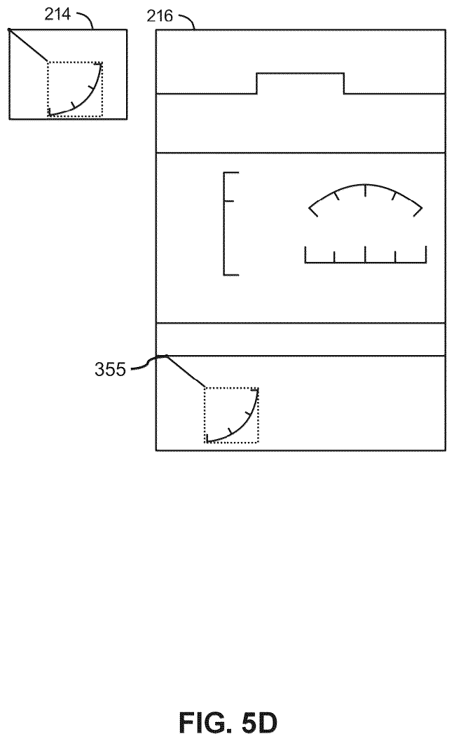

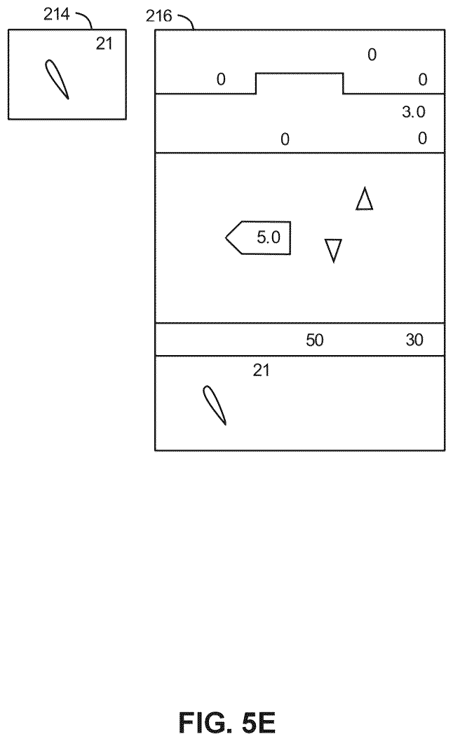

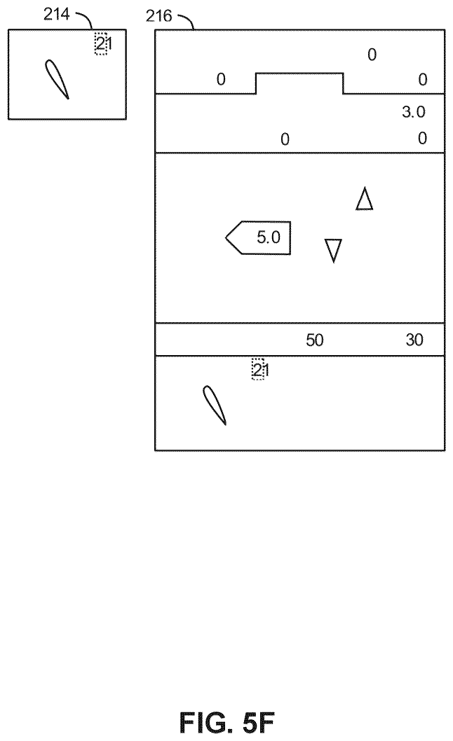

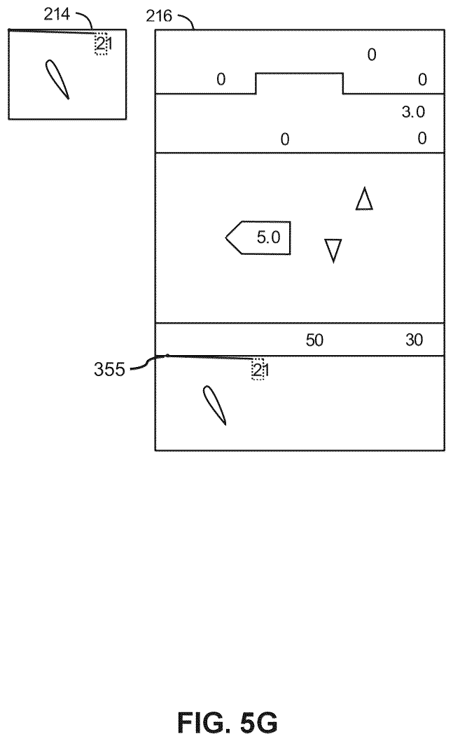

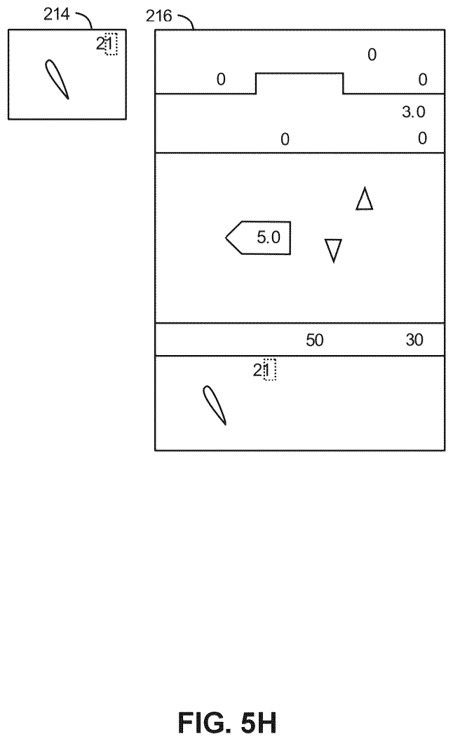

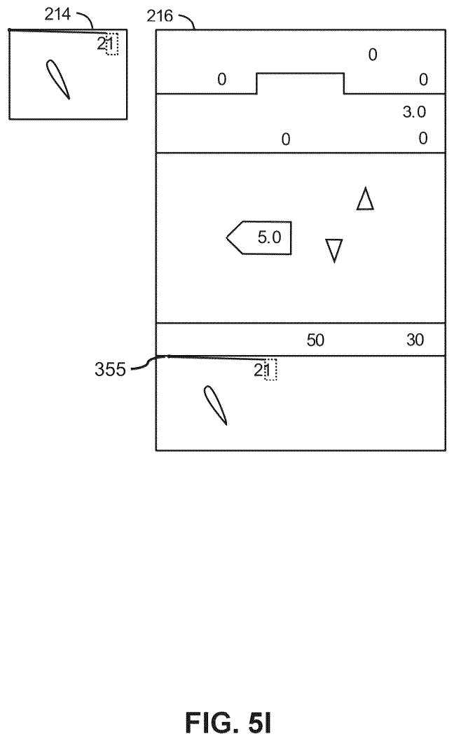

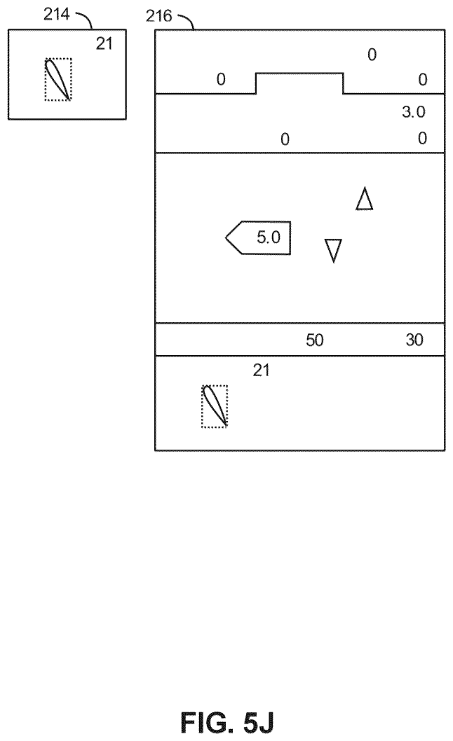

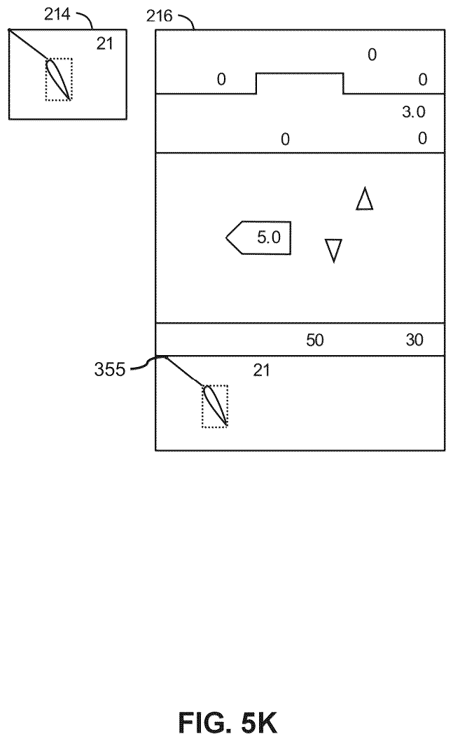

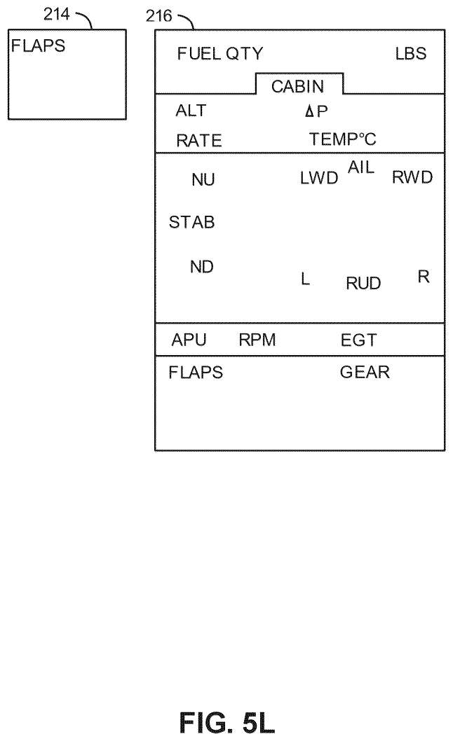

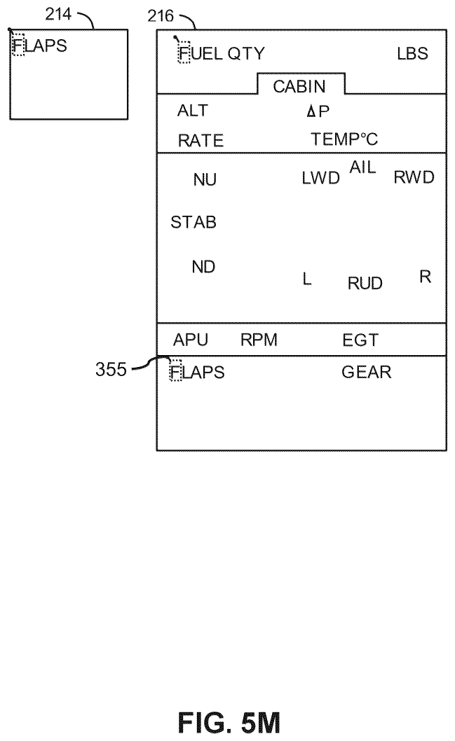

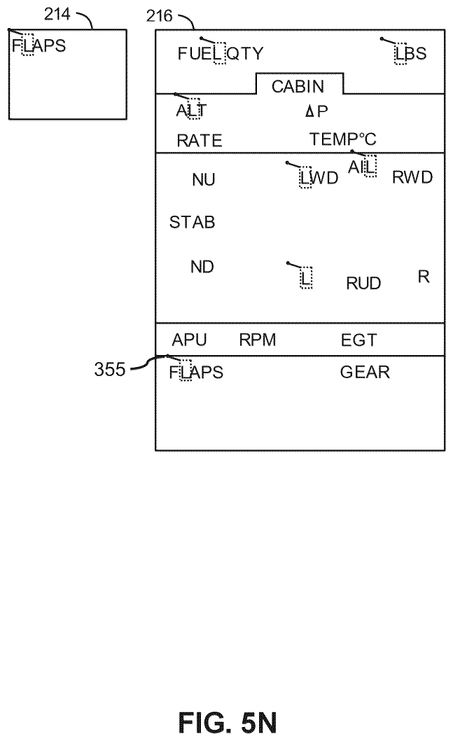

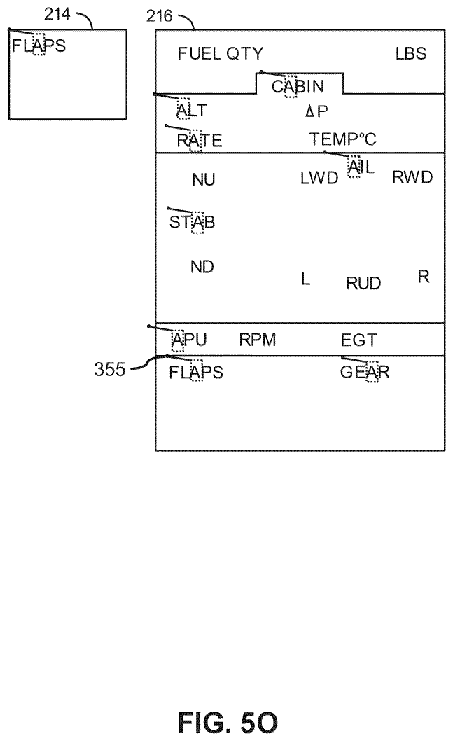

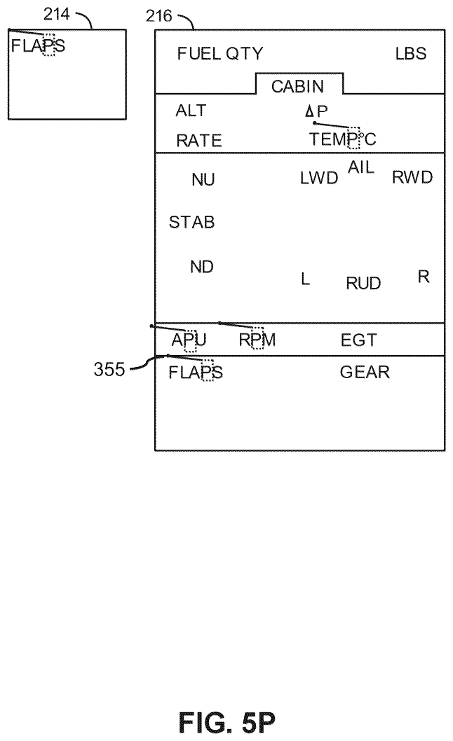

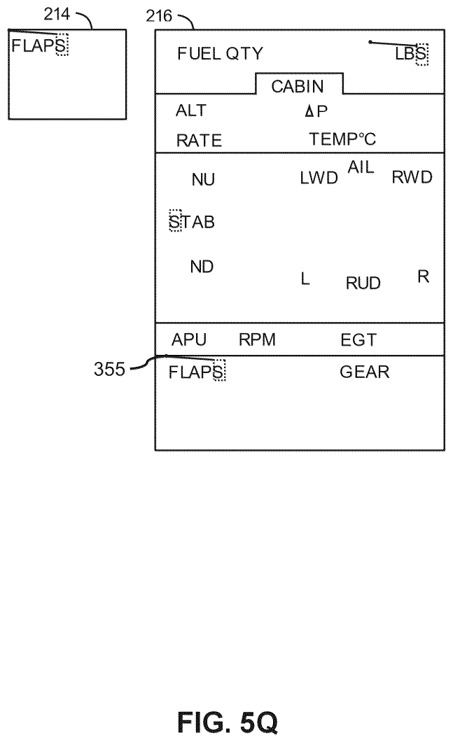

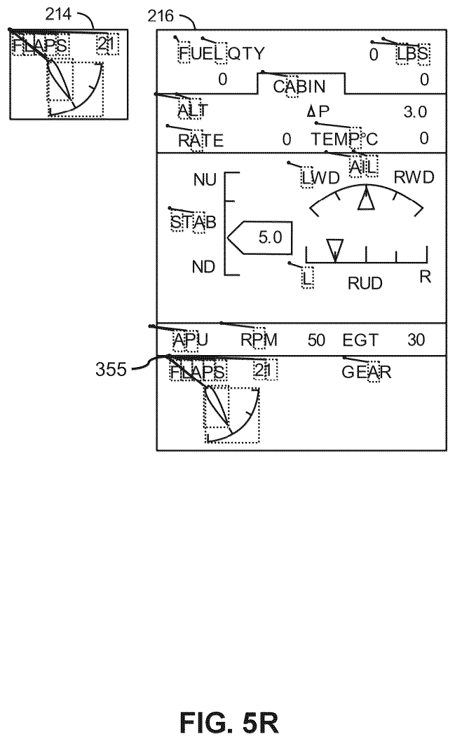

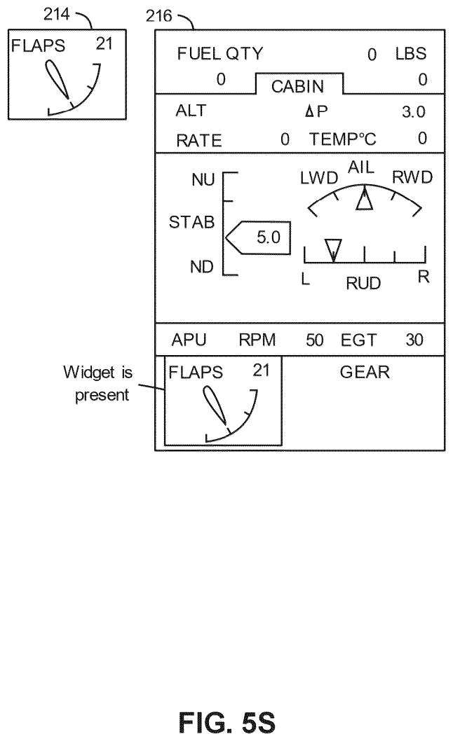

FIGS. 5A-5S depict an example of detecting a match between the widget composition 224 and the GUI composition 226, in accordance with one or more embodiments of the present disclosure. In this example, the graphical user interface 216 include the flaps gauge in combination with various other information. The GUI compositions 226 may be generated for the various contours of the graphical user interface 216. FIG. 5B depicts the white-colored color-segmented graphical user interfaces with the 90-degree dial scale along with various other scales. FIG. 5C depicts detecting a bounding box of the contour defining the 90-degree dial scale in the white-colored color-segmented graphical user interfaces. FIG. 5D depicts the widget origin point 355 for the 90-degree dial scale in the white-colored color-segmented graphical user interfaces. FIG. 5E depicts the green-colored color-segmented graphical user interfaces with the readout of the angular position (e.g., 21) and the pointer along with various other readouts and pointers. FIG. 5F depicts detecting a bounding box of the contour defining the “2” in the green-colored color-segmented graphical user interfaces. FIG. 5G depicts the widget origin point 355 for the “2” in the green-colored color-segmented graphical user interfaces. FIG. 5H depicts detecting a bounding box of the contour defining the “1” in the green-colored color-segmented graphical user interfaces. FIG. 5I depicts the widget origin point 355 for the “1” in the green-colored color-segmented graphical user interfaces. FIG. 5J depicts detecting a bounding box of the contour defining the pointer in the green-colored color-segmented graphical user interfaces. FIG. 5K depicts the widget origin point 355 for the pointer in the green-colored color-segmented graphical user interfaces. FIG. 5L depicts the grey-colored color-segmented graphical user interfaces with the “FLAPS” along with various other indicators. FIG. 5M depicts detecting bounding boxes of the contour defining the “F”s in the grey-colored color-segmented graphical user interfaces and the widget origin point 355 for the “F”s in the grey-colored color-segmented graphical user interfaces. FIG. 5N depicts detecting bounding boxes of the contour defining the “L”s in the grey-colored color-segmented graphical user interfaces and the widget origin point 355 for the “L”s in the grey-colored color-segmented graphical user interfaces. FIG. 5O depicts detecting bounding boxes of the contour defining the “A”s in the grey-colored color-segmented graphical user interfaces and the widget origin point 355 for the “A”s in the grey-colored color-segmented graphical user interfaces. FIG. 5P depicts detecting bounding boxes of the contour defining the “P”s in the grey-colored color-segmented graphical user interfaces and the widget origin point 355 for the “P”s in the grey-colored color-segmented graphical user interfaces. FIG. 5Q depicts detecting bounding boxes of the contour defining the “S”s in the grey-colored color-segmented graphical user interfaces and the widget origin point 355 for the “S”s in the grey-colored color-segmented graphical user interfaces. FIG. 5R depicts the bounding boxes and the widget origin point 355 for each of the widget feature descriptions 230 which match to respective of the GUI feature descriptions 236 for each of the colors. In this depiction there is one position of overlap between the widget origin points 355 for the scale of the white-segmented widget, the 2, 1, and pointer of the green-segmented widget, and the F, L, A, P, and S of the white-segmented widget. The position of overlap indicates the widget 214 is present in the graphical user interface 216. FIG. 5S depicts an overlay of the bounding box of the widget 214 on the graphical user interface 216 at the widget origin point 355 with an indication that the widget 214 is present in the graphical user interface 216.

Referring generally again to the FIGS. The verification computer 206 may implement one or more steps of the method 300 using a test framework in combination with a computer vision pipeline. The test framework may be a test automation framework for acceptance testing the graphical user interface 216. The test framework may be a framework that includes helper functions, wrapper functions, and the like. The test framework may include one or more functions by which a user may prompt the verification computer 206 to execute one or more steps of the method 300. The computer vision pipeline may be a data pipeline in which the graphical user interface 216 may be segmented by colors and the contours may be detected and bounded.

The method 300 may enable presence verifications. Presence verifications may be symbology verifications that only specify that a certain symbol is present or absent. Examples include verifying that a flight director widget is displayed, verifying that a single cue aircraft symbol is displayed, verifying that a sky/ground indication is displayed, verifying that a target altitude bug is displayed, or the like. Presence verifications may not require a specific configuration/state/position relative to other items on the graphical user interface 216.

The method 300 may enable cursor positioning verifications. Cursor positioning verification may be symbology verifications that look for the pilot and/or copilot cursor to be located at a certain position on the display. Examples of the cursor positioning verifications may include verifying that a cursor is positioned at an Engine Indicating and Crew Alerting System (EICAS) format, verifying that a cursor is positioned over a Flight Plan Execute button, or the like.

The method 300 may enable multi-reference positioning verification. Multi-reference positioning verification is a type of symbology verification that looks for a symbol or its element(s) in a certain position relative to another. Examples of multi-reference positioning verification include verifying that the rudder trim pointer is parked at 0, verifying that there are 4 small tick marks above the current altitude pointer, followed by one large tick mark indicating 2,500 feet, verifying that the course pointer points at the course readout value on the compass rose, and the like. Accounting for rotation may be necessary if the feature detection method is rotation-invariant.

The method 300 may be iteratively performed to enable iterative cursor positioning verifications. The iterative cursor positioning verifications may enable verifying that a cursor moves from item-to-item in a pre-selected pattern. The position of the cursor may be detected within multiple of the graphical user interface 216. The cursor may follow a path between symbols when moved via the user interface elements 104 (e.g., dial knob). The dial knob may be rotated to move the cursor to a next symbol.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

Those having skill in the art will appreciate that there are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be affected, none of which is inherently superior to the other in that any vehicle to be utilized is a choice dependent upon the context in which the vehicle will be deployed and the specific concerns (e.g., speed, flexibility, or predictability) of the implementer, any of which may vary.

The previous description is presented to enable one of ordinary skill in the art to make and use the invention as provided in the context of a particular application and its requirements. As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period. For example, the memory may be random access memory (RAM), and the results may not necessarily persist indefinitely in the memory.

It is noted herein that the one or more components of system may be communicatively coupled to the various other components of system in any manner known in the art. For example, the one or more processors may be communicatively coupled to each other and other components via a wireline connection or wireless connection.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed:

1. A method comprising:
segmenting a graphical user interface (GUI) by a plurality of GUI colors into a plurality of color-segmented graphical user interfaces;
detecting a plurality of contours within the plurality of color-segmented graphical user interfaces;
computing a plurality of GUI feature descriptions and a plurality of GUI bounds for the plurality of contours;
combining the plurality of GUI colors, the plurality of GUI feature descriptions, and the plurality of GUI bounds into a GUI composition; and
comparing the GUI composition with a widget composition of a widget to detect the widget composition is present in the graphical user interface.

2. The method of claim 1, wherein the widget composition comprises a plurality of widget colors, a plurality of widget feature descriptions, and a plurality of widget bounds, wherein comparing the GUI composition with the widget composition to detect the widget composition is present in the graphical user interface comprises:
matching the plurality of widget feature descriptions to the plurality of GUI feature descriptions and verifying that the plurality of widget colors associated with the plurality of widget feature descriptions match the plurality of GUI colors which are associated with the plurality of GUI feature descriptions;
determine a plurality of widget origin points in the graphical user interface for the plurality of GUI feature descriptions which match the plurality of widget feature descriptions based on the plurality of widget bounds and the plurality of GUI bounds; and
determining the plurality of widget origin points are at a common point on the graphical user interface.

3. The method of claim 2, wherein a pixel tolerance is added to the plurality of widget origin points when determining the plurality of widget origin points are at the common point.

4. The method of claim 1, wherein the plurality of GUI feature descriptions comprise at least one of edges, corners, blobs, ridges, colors, key points, or moments.

5. The method of claim 4, wherein the plurality of GUI feature descriptions are Zernike moments.

6. The method of claim 1, wherein each of the plurality of color-segmented graphical user interfaces comprises one or more of the plurality of contours.

7. The method of claim 1, wherein the plurality of GUI bounds comprise a position of the plurality of contours and a size of the plurality of contours.

8. A verification computer comprising:
a memory maintaining program instructions; and
one or more processors configured to execute the program instructions causing the one or more processors to:
segment a graphical user interface (GUI) by a plurality of GUI colors into a plurality of color-segmented graphical user interfaces;
detect a plurality of contours within the plurality of color-segmented graphical user interfaces;
compute a plurality of GUI feature descriptions and a plurality of GUI bounds for the plurality of contours;
combine the plurality of GUI colors, the plurality of GUI feature descriptions, and the plurality of GUI bounds into a GUI composition; and
compare the GUI composition with a widget composition of a widget to detect the widget composition is present in the graphical user interface.

9. The verification computer of claim 8, wherein the verification computer is configured to generate the widget composition and maintain the widget composition in the memory.

10. The verification computer of claim 8, wherein the widget composition comprises a plurality of widget colors, a plurality of widget feature descriptions, and a plurality of widget bounds, wherein comparing the GUI composition with the widget composition to detect the widget composition is present in the graphical user interface comprises:
matching the plurality of widget feature descriptions to the plurality of GUI feature descriptions and verifying that the plurality of widget colors associated with the plurality of widget feature descriptions match the plurality of GUI colors which are associated with the plurality of GUI feature descriptions;
determine a plurality of widget origin points in the graphical user interface for the plurality of GUI feature descriptions which match the plurality of widget feature descriptions based on the plurality of widget bounds and the plurality of GUI bounds; and
determining the plurality of widget origin points are at a common point on the graphical user interface.

11. The verification computer of claim 10, wherein a pixel tolerance is added to the plurality of widget origin points when determining the plurality of widget origin points are at the common point.

12. The verification computer of claim 8, wherein the plurality of GUI feature descriptions comprise at least one of edges, corners, blobs, ridges, colors, key points, or moments.

13. The verification computer of claim 12, wherein the plurality of GUI feature descriptions are Zernike moments.

14. The verification computer of claim 8, wherein each of the plurality of color-segmented graphical user interfaces comprises one or more of the plurality of contours.

15. A system comprising:
a verification computer comprising:
a memory maintaining program instructions; and
one or more processors configured to execute the program instructions causing the one or more processors to:
segment a graphical user interface (GUI) by a plurality of GUI colors into a plurality of color-segmented graphical user interfaces;
detect a plurality of contours within the plurality of color-segmented graphical user interfaces;
compute a plurality of GUI feature descriptions and a plurality of GUI bounds for the plurality of contours;
combine the plurality of GUI colors, the plurality of GUI feature descriptions, and the plurality of GUI bounds into a GUI composition; and
compare the GUI composition with a widget composition of a widget to detect the widget composition is present in the graphical user interface; and
a cockpit display system comprising one or more definition files defining the widget, wherein the cockpit display system is configured to generate the graphical user interface.

16. The system of claim 15, an avionics system configured to execute one or more user applications, wherein the one or more user applications generates one or more function calls to the cockpit display system, wherein the cockpit display system is configured to generate the graphical user interface based on the one or more function calls.

17. The system of claim 16, comprising one or more sensors configured to generate avionics data, wherein the one or more user applications generate the one or more function calls based on the avionics data.

18. The system of claim 16, comprising one or more user interface elements, wherein the one or more user applications are configured to update the one or more function calls based on user interface feedback from the one or more user interface elements.

19. The system of claim 15, comprising one or more flight displays, wherein the cockpit display system causes the one or more flight displays to display the graphical user interface.

20. The system of claim 15, wherein the widget composition comprises a plurality of widget colors, a plurality of widget feature descriptions, and a plurality of widget bounds, wherein comparing the GUI composition with the widget composition to detect the widget composition is present in the graphical user interface comprises:
matching the plurality of widget feature descriptions to the plurality of GUI feature descriptions and verifying that the plurality of widget colors associated with the plurality of widget feature descriptions match the plurality of GUI colors which are associated with the plurality of GUI feature descriptions;
determine a plurality of widget origin points in the graphical user interface for the plurality of GUI feature descriptions which match the plurality of widget feature descriptions based on the plurality of widget bounds and the plurality of GUI bounds; and
determining the plurality of widget origin points are at a common point on the graphical user interface.
